(19) United States
(12) Patent Application Publication
(10) Pub. No.: US 2019/0170121 A1
(43) Pub. Date: Jun. 6, 2019

(54) METHOD FOR MOUNTING COMPONENTS OF A WIND TURBINE

(71) Applicant: Wobben Properties GmbH, Aurich (DE)

(72) Inventor: Samer MTAUWEG, Bremerhaven (DE)

(21) Appl. No.: 16/324,031

(22) PCT Filed: Aug. 8, 2017
(86) PCT No.: PCT/EP2017/070027

§ 371 Date: Feb. 7, 2019

(30) Foreign Application Priority Data
Aug. 10, 2016 (DE) 10 2016 114 833.4

(51) Int. Cl. F03D 13/10; B66C 23/18

(52) U.S. Cl. CPC F03D 13/10; B66C 13/46; B66C 23/185

(57) ABSTRACT

A method of mounting components of a wind turbine which has a plurality of components. At least one of the components is mounted by means of a crane. Position and/or distance information in respect of the component to be mounted is detected by means of a laser scanning unit. The CAD data of the components to be mounted is compared to the detected position and/or distance information for exactly determining position and/or distance of the component to be mounted. The detected position and/or distance information is output to a crane operator. The crane can be controlled based on the detected position and/or distance information of the component to be mounted.

### BACKGROUND

### Technical Field

The present invention concerns a method of mounting components of a wind turbine.

### Description of the Related Art

A wind turbine typically has a large number of components (rotor blades, pod, generator, pylon and so forth) which have to be lifted by means of a crane so that those components can be appropriately mounted. A pylon of a wind turbine for example comprises a multiplicity of pylon segments which are placed one upon the other. Those pylon segments can be made from steel or concrete. Constructing or erecting a wind turbine is heavily dependent on the prevailing weather conditions like for example temperature, wind speed and visibility.

On the German patent application from which priority is claimed the German Patent and Trade Mark Office searched the following documents: US 2015/0 028 609 A1, EP 2 424 811 B1 and DE 10 2007 059 820 A1.

### BRIEF SUMMARY

Provided is a method of mounting components of a wind turbine, which permits erection of a wind turbine even in poor weather conditions.

Thus there is provided a method of mounting components of a wind turbine which has a plurality of components. At least one of the components is mounted by means of a crane. Position and/or distance information with respect to the component to be mounted is detected by means of a laser scanning unit. Computer-aided design (CAD) data of the component to be mounted are used for exactly determining position and/or distance of the component to be mounted. The detected position and/or distance information and the CAD data are compared or matched and those data are output to a crane operator. The crane can be controlled based on the detected position and/or distance information of the component to be mounted.

According to an aspect of the present invention an orientation of the component to be mounted is detected by means of the laser scanning unit and in addition to the position and/or distance information output to the crane operator.

According to an aspect of the present invention the laser scanning unit is in the form of a 2D scanner, and there is provided a camera, wherein the 2D scanner together with the camera detects the position and/or distance information.

According to an aspect of the invention the 3D laser scanner can be used with or without a camera to implement this method.

The invention also involves the use of a kinematic terrestrial laser scanner for detecting position and/or distance information with respect to components of a wind turbine, wherein the components are lifted by means of a crane in the mounting operation. The detected position and/or distance information is communicated to a crane operator of a crane.

The invention also involves the concept of detecting the components of the wind turbine to be mounted (for example a pylon, rotor blades, the pod, the spinner, the generator and so forth) by means of laser scanning for example upon mounting of those components to acquire a feedback about the position and/or orientation of those components. The distance between the laser scanner and the component to be mounted can be determined by means of the laser scanning procedure.

CAD data relating to the components to be mounted can be stored. It is possible to provide for exactly determining the position of the components to be mounted on the basis of the distance detected by means of the laser scanner from the laser scanner and the stored CAD data. In that respect that operation of exactly determining the position of the components is dynamic so that the exact position of the components to be mounted can be determined when raising the components by means of a crane. That position information can be made available for example to a crane operator so that the crane operator can appropriately control the crane to permit exact positioning of the components to be mounted.

The laser scanner can be for example a kinematic terrestrial k-TLS laser scan. The laser scan (mobile measurement or stationary measurement by means of a 3D laser scanner or a synchronized 1D or 2D laser scanner with a camera can permit the spacings and positions of the components to be mounted relative to each other to be exactly ascertained.

CAD models or plans or data with respect to the components to be mounted can be made available beforehand. As an alternative thereto the CAD data can be ascertained by means of a laser scanning procedure in the factory or on the site.

The per se known laser scanning process (for example kinematic terrestrial laser scanning) can be used for determining position and location of components to be mounted during the erection of a wind turbine. In particular it is possible to ascertain the orientation of the component to be mounted with respect to the crane.

As when erecting the wind turbine it is always known by means of the laser scan where the component to be mounted is disposed and what is its orientation the crane operator does no longer need to have visual contact with the component to be mounted. This means that the operation of erecting the wind turbine can be effected even in poor visibility like for example in fog or at night. In that way the time required to erect the wind turbine can be considerably reduced.

According to an aspect of the present invention the laser scanning procedure can be used alone or with an additional camera for generating CAD models or for ascertaining the spacings, relative position and angular locations as between the components which are to be mounted or which have already been mounted of the wind turbine.

According to an aspect of the present invention it is possible to use a kinematic terrestrial k-TLS laser scan for geodetic monitoring whereby it is possible to detect fast movements and deformation of measurement objects. In addition it is possible to use mobile mapping to detect geometrical ambient information from a moving platform.

A laser scanner can be provided on the ground or on a crane. The laser can optionally be operated in a 3D mode. Alternatively thereto the laser scanner can be operated in a 1D or 2D mode in combination with a camera. The laser scanner and the camera can be placed on the ground or on an installation crane.

According to the invention it is possible to reduce the crane maneuvering times as mounting is made possible even at night or when there is adverse visibility.

According to an aspect of the present invention it is possible with the laser scanner, optionally using the available CAD data of the components to be mounted, to determine the relative position of the component with respect to the scanner, and the angular position of the components to be mounted.

The component to be mounted can be detected by means of a laser scan so that a CAD model can be produced. Alternatively the construction data of the components of the wind turbine can be used.

Optionally a CAD model can be generated by means of the dimensions of the components to be mounted, that are detected for example on site by a laser scanner.

By means of the previously ascertained CAD data and the measurement data of the laser scanner it is possible to determine the relative position and the angular location of the component to be mounted during the mounting procedure. The crane can be more accurately controlled by means of those details so that the components to be mounted can be appropriately mounted in place.

Further configurations of the invention are subject-matter of the appendant claims.

### BRIEF DESCRIPTION OF THE SEVERAL VIEWS OF THE DRAWINGS

Advantages and embodiments by way of example of the invention are described in greater detail hereinafter with reference to the drawing.

FIG. 1 shows a diagrammatic view of a wind turbine,

FIG. 2 shows a diagrammatic view of an area around a wind turbine when mounting the wind turbine,

FIG. 3 shows a diagrammatic view of a wind turbine when mounting a rotor blade, and

FIG. 4 shows a diagrammatic view of a method according to the invention of mounting components of a wind turbine.

### DETAILED DESCRIPTION

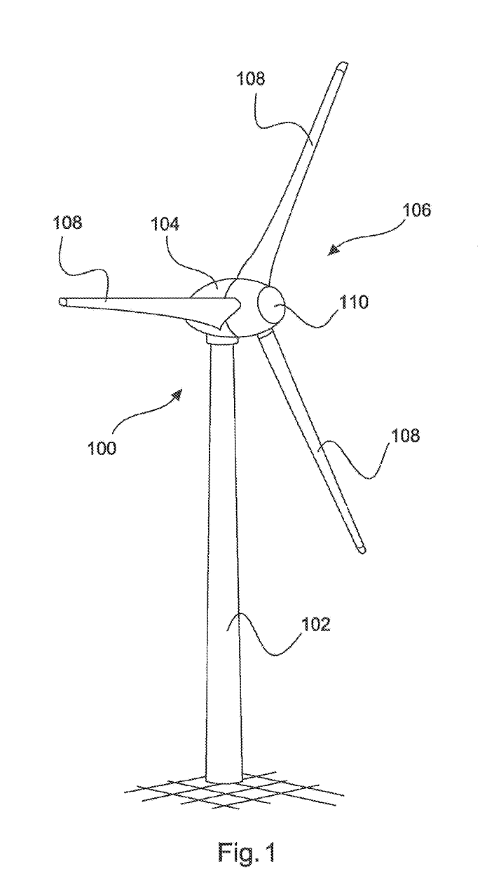

FIG. 1 shows a diagrammatic view of a wind turbine. FIG. 1 shows a wind turbine 100 comprising a pylon 102 and a pod 104. Arranged at the pod 104 is an aerodynamic rotor 106 having three rotor blades 108 and a spinner 110. In operation the aerodynamic rotor 106 is rotated by the wind and thereby drives a generator in the pod 104 to generate electric power.

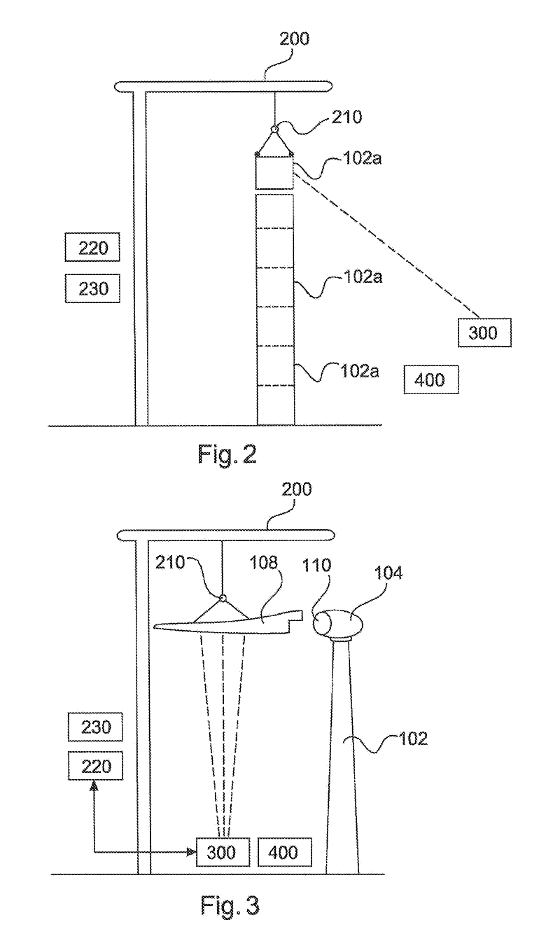

FIG. 2 shows a diagrammatic view of a pylon of a wind turbine for example as shown in FIG. 1 during the mounting operation. The pylon 102 has a plurality of pylon segments 102a which are placed one upon the other. The pylon segments 102a can be lifted upwardly from the ground by means of a crane and placed on the upper pylon segment 102a. During that operation of mounting the pylon segment 102a a laser scanning unit 300 detects the pylon segment 102a to be mounted in position. The position and the distance between the pylon segment 102a to be mounted and the laser scanning unit 300 is detected by means of the laser scanning unit 300 which for example is in the form of a kinematic terrestrial laser scanning unit. That position or distance information can be passed from the laser scanning unit 300 to a control unit 220 of the crane 200. As an alternative thereto that position and distance information can be passed to an operator of the crane. The crane operator or the control unit 220 can then appropriately influence the position of the pylon segment 102a in order to place it exactly on the other pylon segments 102a.

The laser scanner 300 and the camera 400 can monitor the parts 102a to be mounted and the base on which the parts are to be mounted.

FIG. 3 shows a diagrammatic view of a wind turbine when mounting a rotor blade. The rotor blade 108 is conveyed upwardly by means of a crane hook 210 and a crane 200 so that the rotor blade 108 can be fixed to the pod 104 and to the spinner 110. During the operation of mounting the rotor blade 108 a laser scanning unit 300 detects the position of the rotor blade or the distance from the laser scanning unit 300. In addition, the orientation of the rotor blade 108 together with the position can be detected by means of the laser scanning unit 300. That position and distance information can be output to a control unit 220 of the crane. Alternatively or in addition thereto that information can be output to a crane operator. For example that information can be displayed on a display unit 230 of the crane.

The laser scanning unit 300 and the camera 400 can monitor the parts 108 to be mounted (the blade) and the base 110 (the hub) on which the parts are to be mounted.

According to an aspect of the present invention the laser scanning unit 300 (or another unit) can have CAD data of the components of the wind turbine that are to be mounted, or can have access thereto. The laser scanning unit 300 can compare those CAD data to the position information, detected thereby, with respect to the components to be mounted in order to permit exact mounting of the parts to be mounted in position. The position information can be ascertained even in poor visibility by means of the laser scan which is used for example in the form of a kinematic terrestrial k-TLS laser scan. In that way the use of the laser scanning unit permits components of the wind turbine to be mounted in place even in poor visibility like for example when there is fog or in darkness.

By means of the laser scanning unit 300 it is possible for example to give a crane operator feedback about the currently prevailing position and/or orientation of the component to be mounted even in poor visibility. This means that the erection of the wind turbine can be substantially speeded up.

According to an aspect of the present invention the laser scanning unit 300 can be used to detect CAD data of the components to be mounted, on the site.

According to an aspect of the present invention a camera 400 can optionally be provided in addition to the laser scanning unit 300.

The use of a kinematic terrestrial laser scanning unit makes it possible to detect rapid movements and deflections of the components to be mounted.

The laser scanning unit 300 can be provided on the ground, on the crane or elsewhere on the site (for example on a motor vehicle or a truck). The unit not only scans the component to be mounted but also the base to which the component is fitted. The laser can be operated for example in a 3D mode. As an alternative thereto the laser scanner can be operated in 1D or 2D mode in conjunction with the camera 400 to acquire position information with respect to the components to be mounted.

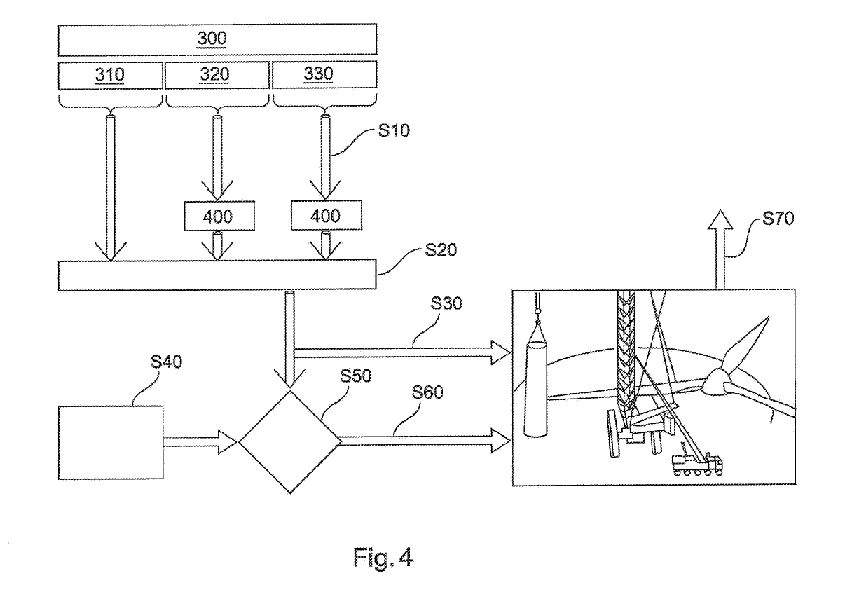

FIG. 4 shows a diagrammatic view of a method of mounting components of a wind turbine. The laser scanning unit 300 can be operated in a 3D mode 310, a 2D mode 320 or a 1D mode 330, or can be in the form of a 3D, 2D or 1D laser scanner. In step S10 the laser scanning unit 300 is activated. If the laser scanning unit 300 is activated in the 2D mode 320 then a camera 400 can also be activated. If the laser scanning unit 300 is activated in a 1D mode 330 then the camera 400 can also be activated. In step S20 based on the measurement results of the laser scanning unit 300 in step S10 a CAD model is produced or recourse is had to an existing CAD model and/or a distance measurement operation is carried out. In step S30 the coordinates of the component to be detected are ascertained and the distances are determined. That information can then be output for example to the crane operator in step S70.

A CAD model can be made available in step S40 or it is possible to have recourse to the CAD model. The CAD model can concern the overall wind turbine or components of the wind turbine. Step S50 involves comparison of the data of the CAD model and the detected coordinates and/or distances of the element to be detected. In step S60, based on the model comparison in step S50, the coordinates and/or the distances relative to the laser scanning unit 300 are ascertained and for example in step S70 output to the crane operator. In that way mounting or erection of the wind turbine can be considerably improved as the components of the wind turbine can be fitted in position even in poor visibility like for example fog, darkness and so forth.

1. A method comprising:
mounting a plurality of components of a wind turbine, the mounting comprising:
lifting at least one component of the plurality of components using a crane;
detecting at least one of: position information, distance information, and an orientation of the at least one component to be mounted using a laser scanning unit;
comparing CAD data for the at least one component to be mounted to at least one of: the detected position information, the detected distance information, and the detected orientation for determining more precise position information and distance information of the at least one component to be mounted;
outputting at least one of: the more precise position information and the more precise distance information to a crane operator; and
controlling the crane based on at least one of: the more precise position information, distance information, and the orientation of the at least one component to be mounted.

2. (canceled)

3. The method according to claim 1 wherein the CAD data are based on a CAD model or are acquired by scanning the at least one component to be mounted.

4. The method according to claim 1 wherein the laser scanning unit is a 2D scanner, and wherein detecting the at least one of: position information, distance information, and the orientation of the at least one component to be mounted involves using the 2D scanner together with a camera.

5. The method according to claim 1 wherein the laser scanning unit is a 3D scanner, and wherein detecting at least one of: position information, distance information, and the orientation of the at least one component to be mounted involves using the 3D scanner together with a camera.

6. The method according to claim 5 wherein at least one of: the laser scanning unit and the camera are provided on the ground or on the crane.

7. A method of using a kinematic terrestrial laser scanner for detecting at least one of: position information, distance information, and orientations of components to be mounted on a wind turbine, wherein the method comprises:
lifting the components using a crane in a mounting operation;
detecting at least one of: position information, distance information, orientation of the components to be mounted;
comparing at least one of: the detected position information, the detected distance information, and the orientation of the components to be mounted to CAD data of the component to be mounted; and
communicating at least one of: the compared position information, the compared distance information, and the compared orientation of the components to be mounted to a crane operator of a crane.

8. The method according to claim 4 wherein at least one of: the laser scanning unit and the camera are provided on the ground or on the crane.
